(19) United States
(12) Patent Application Publication
(10) Pub. No.: US 2005/0219013 A1
(43) Pub. Date: Oct. 6, 2005

(54) Comb-line filter

(76) Inventors: Pavan Kumar, Dollard-des-Ormeaux (CA); Roland Richard, Beaconsfield (CA); Jean-Marc Roberge, Kirkland (CA)

Correspondence Address: BRINKS HOFER GILSON & LIONE, P.O. BOX 10395, CHICAGO, IL, 60610, US

(21) Appl. No.: 10/820,224

(22) Filed: Apr. 6, 2004

(51) Int. Cl. H01P 1/205

(52) U.S. Cl. 333/203

(57) ABSTRACT

A comb-line filter and method of manufacturing the comb-line filter. The comb-line filter comprising a housing and at least one resonator. The housing comprises a first portion and a second portion, wherein the first portion is made of a dielectric material and the second portion is made of a conductive material. The first portion and the second portion are adapted for being attached together so as to define an interior chamber for conducting signals. The at least one resonator is attached to the second portion, and is adapted for extending within the interior chamber when the first portion and the second portion are attached. Comb-line filters in accordance with the present invention provide relatively low-cost and light-weight composite material comb-line filters.

### FIELD OF THE INVENTION

The present invention relates generally to the field of comb-line filters, and more specifically to comb-line filters that are made of a combination of dielectric and conductive materials.

### BACKGROUND

Comb-line filters for filtering wireless signals are known in the art. Typically, comb-line filters include a metal housing that includes a base portion and a lid, with a set of resonators integrally molded or bolted on to the base portion. During use, wireless/microwave signals enter the filter housing and follow a signal pathway around/through the resonators. Depending on the position and configuration of the resonators, the frequency response of the filter can be tailored to suit specific operational needs.

A disadvantage associated with conventional metal filters is that they are heavy in weight, and are expensive to produce and transport.

One method aimed at overcoming some of the disadvantages of the metal filters described above, is to use so-called “plastic” filters. Typically, plastic filters include a base portion having resonators thereto, wherein the base portion and resonators are coated with a conductive film. Such filters provide the advantage that they are lightweight, and relatively inexpensive. However, a disadvantage associated with plastic filters is that the plastic material is a poor thermal conductor, thereby rendering the filter unable to effectively dissipate the heat caused by electrical current flow in the conductive film or caused by the insertion loss of the filter. Since it is generally accepted that an important factor in the power handling of a filter is the filter's heat dissipation arrangement, such plastic filters provide unsatisfactory power handling.

Accordingly, there exists a need in the industry for an improved comb-line filter that is both lightweight, relatively inexpensive, and provides a high quality of power handling.

### BRIEF SUMMARY

As embodied and broadly described herein, the invention provides a comb-line filter comprising a housing and at least one resonator. The housing comprises a first portion and a second portion, wherein the first portion is made of a dielectric material and the second portion is made of a conductive material. The first portion and the second portion are adapted for being attached together so as to define an interior chamber for conducting signals. The at least one resonator is attached to the second portion, and is adapted for extending within the interior chamber when the first portion and the second portion are attached.

In a specific example of implementation, the first portion is made of plastic.

As further embodied and broadly described herein, the invention provides a method of manufacturing a comb-line filter. The method comprises providing a first portion made of a dielectric material, providing a second portion made of a conductive material, and attaching the first portion and the second portion together to form an interior chamber suitable for conducting signals. The second portion has at least one resonator connected thereto.

As still further embodied and broadly described herein, the invention provides a comb-line filter comprising a housing and at least one resonator. The housing comprises a first portion made of a material of a first density, and a second portion made of a metal material of a second density. The first density is less than the second density. The first portion and the second portion are adapted for being attached together so as to define an interior chamber for conducting signals. The at least one resonator is attached to the second portion, and is adapted for extending within the interior chamber when the first portion and the second portion are attached.

As still further embodied and broadly described herein, the invention provides a comb-line filter comprising a housing and at least one resonator. The housing comprises a first portion made of a first material and a second portion made of a second material. The second portion is provided with a conductive layer that is more conductive than the first material of the first portion. The first portion and the second portion are adapted for being attached together so as to define an interior chamber for conducting signals. The at least one resonator is attached to the second portion, and is adapted for extending within the interior chamber when the first portion and the second portion are attached together.

These and other aspects and features of the present invention will now become apparent to those of ordinary skill in the art upon review of the following description of specific embodiments of the invention in conjunction with the accompanying drawings.

### BRIEF DESCRIPTION OF THE DRAWINGS

A detailed description of the embodiments of the invention is provided herein below with reference to the following drawings, wherein:

FIG. 1 shows an exploded view of a comb-line filter in accordance with a non-limiting embodiment of the present invention;

FIG. 2 shows the comb-line filter of FIG. 1 in an assembled state in accordance with a non-limiting embodiment of the present invention;

FIG. 3 shows a detailed view of a resonator from the comb-line filter shown in FIGS. 1 and 2;

FIG. 4 shows a cross-sectional view of one corner of the comb-line filter of FIG. 1, with a representation of the distribution of electric current flow therein, in accordance with a non-limiting embodiment of the present invention;

FIG. 5 shows an exploded view of a comb-line filter in accordance with a second non-limiting embodiment of the present invention;

FIG. 6 shows an exploded view of a comb-line filter in accordance with a third non-limiting embodiment of the present invention; and

FIG. 7 shows a tuning screw in accordance with an alternative, non-limiting embodiment of the present invention.

In the drawings, embodiments of the invention are illustrated by way of examples. It is to be expressly understood that the description and drawings are only for the purpose of illustration and are an aid for understanding. They are not intended to be a definition of the limits of the invention.

### DETAILED DESCRIPTION

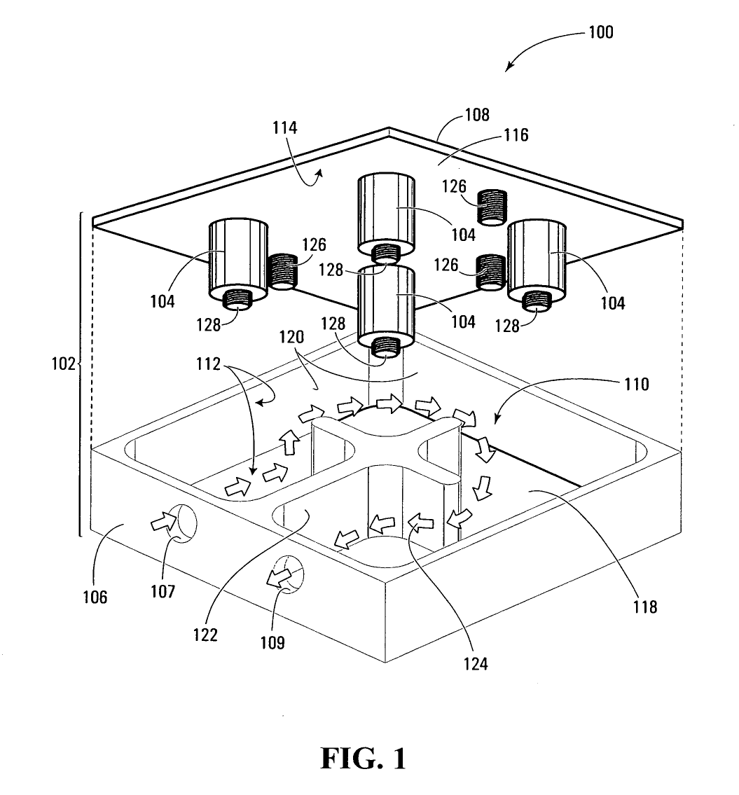

Shown in FIG. 1 is an exploded view of a comb-line filter 100 in accordance with a first non-limiting example of implementation of the present invention. Generally speaking, and without limiting the scope of the present invention, the comb-line filter 100 is operative for filtering signals having frequencies in the range of 400 Mhz to 4 Ghz.

Housing 102

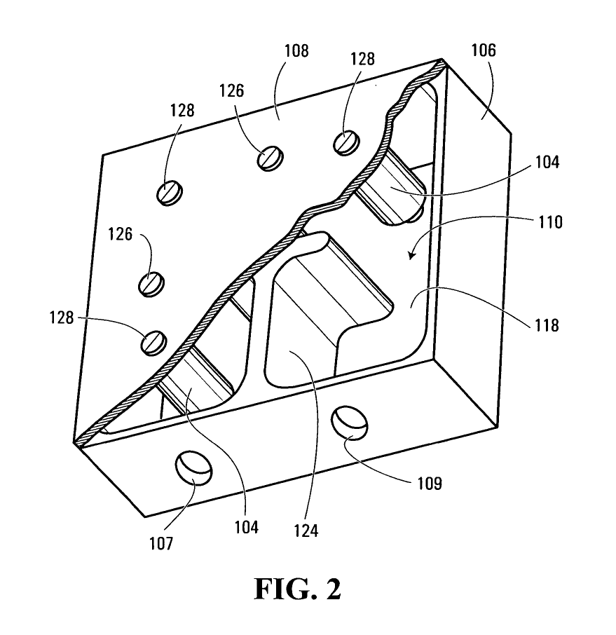

As shown in FIG. 1, the comb-line filter 100 includes a housing 102 and a plurality of resonators 104. The housing 102 of the comb-line filter 100 includes a first portion 106 and a second portion 108 that are adapted for being attached together, as shown in FIG. 2. In a non-limiting embodiment of the present invention, the first portion 106 of the housing 102 is made of a dielectric material and the second portion 108 is made of a conductive material. As will be described in more detail further on, the resonators 104 are attached to the second portion 108 of the housing 102, which is the portion that is made of a conductive material.

In a specific, non-limiting embodiment, the dielectric material is a plastic material, such as glass fiber reinforced polyethermide resin. The plastic material can also be made of a thermo-set material or of a thermal plastic material. In addition, in a specific, non-limiting embodiment, the conductive material is aluminum. Other non-limiting examples of dielectric materials suitable for forming the first portion 106 of the housing 102 include other plastics, as well as polymers, wood and glass. In addition, other non-limiting examples of conductive materials suitable for forming the second portion 108 of the housing 102 include other metals, such as aluminum, steel, copper, and nickel, as well as metal alloys. As will be described below, these materials can be provided with a conductive coating, such as silver plating, for example.

An advantage of forming the first portion 106 out of a dielectric material, and particularly one that has a lighter density than the second portion 108, is that it creates a lightweight comb-line filter 100 that that is easier to handle. In addition, it is generally easier to manufacture the first portion 106 out of a dielectric material, such as plastic, than it would be to manufacture the first portion 106 out of a conductive material, such as metal. The first portion 106 of the housing 102 can be manufactured via molding, machining, or any other manufacturing technique known in the art. By making the first portion 106 out of a dielectric material, the costs associated with the choice of material, the manufacturing of the filter, the application of a conductive layer and the transportation of the filter 100, can be reduced.

As shown in FIG. 2, the first portion 106 and the second portion 108 of the housing 102 are adapted for being attached together. It should be understood that the first portion 106 and the second portion 108 can be attached together in a variety of different manners. For example, the second portion 108 can be fastened to the second portion 108 of the housing 102 via screws (not shown) that are attached through the second portion 108, and extend into pre-drilled threaded holes (not shown) in the walls 112 of the first portion 106. In an alternative embodiment, the first portion 106 and the second portion 108 are designed such that they are attached together via a snap-fit arrangement. Other methods of attaching the first portion and the second portion together are also included within the scope of the present invention.

As shown in FIG. 1, the first portion 106 of the housing 102 includes an inner surface 112, and the second portion 108 of the housing 102 includes an interior surface 114. When the first portion 106 and the second portion 108 of the housing 102 are attached together, as shown in FIG. 2, the inner surface 112 and the interior surface 114 define an interior chamber 110 for conducting signals therethrough. For the purposes of clarity, FIG. 2 shows the second portion 108 of the housing 102 as being partially cut away such that the interior chamber 110 of the housing 102 is visible. As shown in both FIGS. 1 and 2, the housing 102 includes a first hole 107 for allowing signals to enter the interior chamber 110, and a second hole 109 for allowing signals to exit the interior chamber 110. It should be understood that the signals can both enter and exit both of holes 107 and 109. In general, the signals enter and exit the filter 100 through connectors that are positioned within holes 107 and 109. However, the signals can also enter and exit the filter 100 via other methods.

In order for the interior chamber 1 10 to be able to conduct signals therethrough, at least the inner surface 112 of the first portion 106 and the interior surface 114 of the second portion 108 include a conductive layer. This conductive layer may be applied by a coating process for example.

In a non-limiting embodiment, the conductive layer is made of a layer of silver, and/or copper and nickel having a thickness in the range of 2.5 to 29 micro meter (μm). It should be understood that the conductive layer can be made of other materials known in the art. The thickness of the conductive layer may depend on the frequency range of operation of the filter. As frequency increases, conduction occurs in an increasingly thin layer of conductive material. Those skilled in the art will be able to determine an appropriate thickness for the conductive layer, depending on the frequency of the signals being filtered. It should be understood that the conductive layer could also be made of other materials such as chromium and white bronze, for example. Different methods of providing the conductive layer will be known to those of skill in the art, and as such will not be described in more detail herein.

In an alternative embodiment, the conductive layer applied to the interior surface 114 of the second portion 108 and the conductive layer applied to the inner surface 112 of the first portion 106 can be formed from different materials, having different conductivities.

In some cases, it may be desirable for the first portion 106 and the second portion 108 to expand and contract at substantially the same rate when attached together. To this end, the dielectric material of the first portion 106 and the conductive material of the second portion 108 are selected to have respective coefficients of thermal expansion (C_{TE}) that are thermally compatible. It may be advantageous for the coefficient of thermal expansion (C_{TE}) of the dielectric material to be within 20%, or even 10% or less, of the coefficient of thermal expansion (C_{TE}) of the conductive material.

In addition, those skilled in the art will recognize that the dielectric material that forms the first portion 106 of the housing is thermally and electrically stable, given the working environment in which it is supposed to function. For example, the dielectric material may be called upon to perform in an environment with a working temperature in the range of −40° C. to 85° C. or more.

In the non-limiting embodiment shown in FIGS. 1 and 2, the interior chamber 110 is defined by a top wall 116, a bottom wall 118 and exterior side walls 120 that connect the top wall 116 to the bottom wall 118. Although four exterior side walls 120 have been shown in FIGS. 1 and 2, the comb-line filter 100 could include a greater or lesser number of exterior side walls 120 without departing from the spirit of the invention. For example, in the case where the top wall 116 and the bottom wall 118 are circular in shape, there will be only one exterior side wall 120, that would be of a cylindrical shape.

As shown in FIGS. 1 and 2, the first portion 106 of the housing 102 also includes an interior wall 122 that defines a signal pathway through the comb-line filter 100. The signal pathway is represented by arrows 124. The interior wall 122 is positioned within the interior chamber 110 when the first portion 106 and the second portion 108 of the housing 102 are attached together. In the non-limiting embodiment shown, the interior wall 122 defines a signal pathway 124 that travels from one of holes 107 and 109, to the other one of holes 107 and 109. Although only one interior wall 122 has been shown in FIGS. 1 and 2, it should be understood that any number of interior walls 122, having any suitable shape and configuration, can be positioned within the interior chamber 110 so as to create a desired signal pathway 124. In the case where there are multiple interior walls 122, there may not be one continuous signal pathway. For example, it is possible that the signal pathway might branch off into different directions, thereby creating multiple signal pathways within the interior chamber 110. The different configurations of interior walls 122 will be known to those of skill in the art, and as such will not be described in more detail herein.

In the non-limiting embodiments shown in FIGS. 1 and 2, the exterior side walls 120 and the interior wall 122 are shown as being part of the first portion 106 of the housing 102. As such, both the exterior side walls 120 and the interior wall 122 are made of the same dielectric material as the first portion 106, and include a conductive layer. In an alternative embodiment, the exterior side walls 120, the interior wall 122, or both, can be included as part of the second portion 108, and as such, would be made of the conductive material of the second portion 108.

In an alternative embodiment, it is within the scope of the present invention for the exterior surfaces of the housing 102 to include a non-conductive plating.

Resonators 104

As mentioned above, the comb-line filter 100 includes a plurality of resonators 104, which as shown in FIG. 1, are attached to the interior surface 114 of the second portion 108 of the housing 102. As such, the resonators 104 are attached to the portion of the housing 102 that is made of the conductive material.

In a non-limiting embodiment, the resonators 104 are made of the same conductive material as the second portion 108 of the housing. As such, in keeping with the example described above, in the case where the second portion 108 is made of aluminum, the plurality of resonators 104 can also be made of aluminum. In an alternative embodiment, the resonators 104 can be made of a material that is different from the material of the second portion 108. For example, the resonators 104 can be made of other metals, metal alloys, ceramics and thermoplastics. In the cases where the resonators 104 are not made of a conductive material, the resonators 104 include a conductive layer thereon, so that they are able to conduct the wireless signals. As described above, in a non-limiting embodiment, the conductive layer can include silver, and can be of a thickness in the order of 2.5 to 25 m.

The resonators 104 can be attached to the second portion 108 of the housing 102 in a variety of different manners. For example, in the case where the resonators 104 are made of the same material as the second portion 108 of the housing 102, the resonators 104 can be machined from the same block of material as the second portion 108. In such an embodiment, the resonators 104 would be made integrally with the second portion 108 of the housing 102. In an alternative embodiment, the resonators 104 can be manufactured separately and then soldered, adhered, bolted, screwed, or fastened to the second portion 108 of the housing in any other manner known in the art.

As shown in FIG. 2, when the first portion 106 and the second portion 108 of the housing 102 are attached together, the plurality of resonators 104 extend from the interior surface 114 of the second portion 108 into the interior chamber 110. The resonators 104 do not come into contact with the bottom wall 118 of the interior chamber 110.

In the embodiment shown, the resonators 104 have a generally cylindrical configuration. However, it should be understood that the resonators 104 can be of any other suitable configuration, such as rectangular, triangular, star-shaped, etc . . . without departing from the spirit of the invention. It should also be understood that not all of the resonators 104 contained in the housing 102, need to be of the same configuration. For example, one resonator 104 can be cylindrical, and the other resonators 104 can be of a rectangular shape. In addition, the resonators contained within the housing can be made of different materials. For example, one or more resonators could be made of a dielectric material, and the other resonators could be made of a conductive material.

The positioning and configuration of the resonators 104 on the interior surface 114 of the second portion 106, which determines their position within the interior chamber 110 of the housing 102, will depend on the desired response characteristics of the filter. More specifically, when designing the comb-line filter 100, the resonators 104 can be suitably configured and positioned at certain locations on the interior surface 114 of the second portion 108 so as to create desired response characteristics for the filter 100. The manner in which the resonators 104 should be positioned, as well as the number of resonators required to achieve a desired response characteristic, will be understood by those skilled in the art, and as such will not be described in more detail herein.

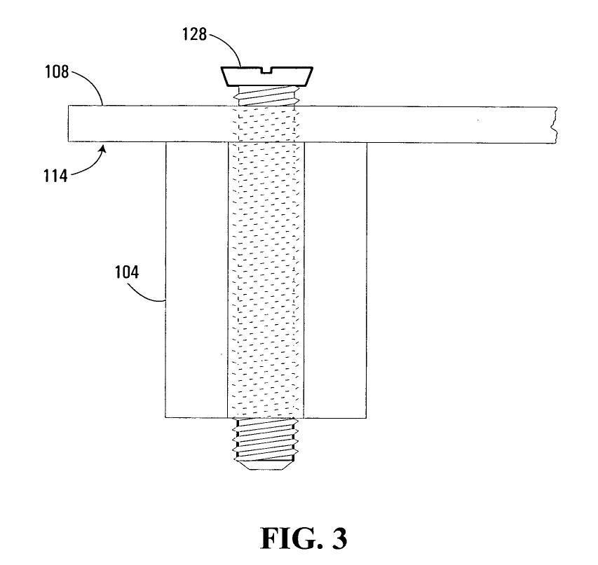

In order to further adjust the desired response characteristics of the comb-line filter 100, the comb-line filter 100 includes a plurality of tuning screws 128. In the non-limiting embodiment shown in FIGS. 1 and 2, the tuning screws 128 are connected to the second portion 108 of the housing 102, and extend through the center of the resonators 104. FIG. 3 shows a detailed view of one of the resonators 104 with a tuning screw 128 extending therethrough. As shown, the resonator 104 is of a generally hollow cylindrical shape such that the tuning screw 128 that is connected to the second portion 108 of the housing 102 can extend through the center of the resonator 104. As such, the diameter of the hollow cylindrical hole through the resonator 104 can be equal to, or greater than, the diameter of the tuning screw. In addition, the hollow cylindrical hole through the resonator 104 can include threads fully therethrough, or at least along a portion of the periphery of the hole.

In order to adjust the response characteristics of the filter 100, the tuning screw 128 can be rotated from the top surface of the second portion 108, to control the extent to which the tuning screw 128 extends from the end of the resonator 104. This changes the characteristics of the signal pathway which changes the frequency response characteristics of the comb-line filter 100. It is noted that even when the tuning screws 128 are in a maximally extended position, there will be a separation between the tuning screw 128 and the bottom wall 118 of the interior chamber 110, which should be sufficient to prevent a breakdown of the electric field existing therebetween.

The comb-line filter 100 further includes one or more coupling screws 126 for adjusting the response characteristics of the filter 100. The coupling screws 126 are positioned between respective resonators 104 within the interior chamber 110 and are adapted to help the wireless signals travel from one resonator 104 to the next. The positioning and configuration of the coupling screws 126 will depend on the desired response characteristics of the filter 100. In the embodiment shown, the coupling screws 126 are attached to the second portion 108 of the housing 102 via threaded holes in the second portion 108. As such, the response characteristics of the filter 100 can be adjusted by rotating the top surface of the coupling screws 126 (as shown in FIG. 2) to control the extent to which the coupling screw 126 extends within the interior chamber 110.

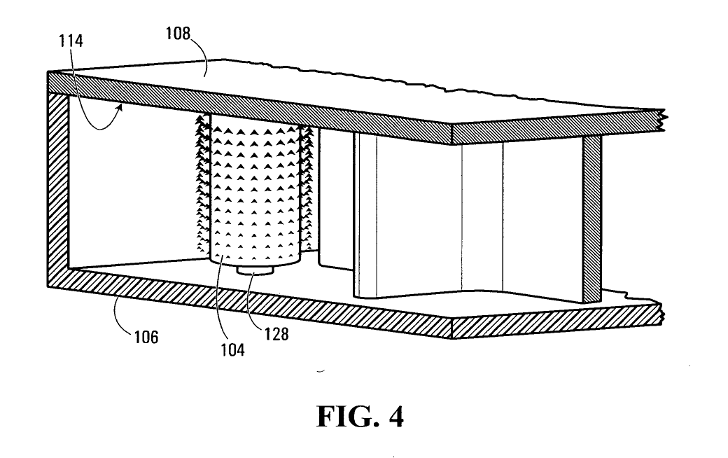

FIG. 4 shows a representation of the electrical current flow surrounding a resonator 104 within the interior chamber 110 of the housing 102. The current is generated upon inserting the filter 100 into an electrical circuit and providing it with a wireless signal to conduct within the chamber. These currents cause the conductor losses, which are at least partly responsible for the “insertion loss” of the comb-line filter 100. The more conductive or less resistant, the surfaces of the resonators 104 and interior surfaces 114 of the housing 102, the less “insertion loss” is generated by the filter 100. The interior surface 112 has less effect on the insertion loss compared to surface 114 and resonators 104. In FIG. 4, the current is shown as traveling along the body of the resonator 104 towards the second portion 108 of the housing. As the electrical current travels through the conductive layer, or the resonator 104 itself, insertion loss is caused, which is ultimately converted into heat. Based on the diagram shown, electrical current flow is largest where the resonator 104 joins the interior surface 114 of the second portion 108. As such, the majority of the heat attributable to the insertion loss will be transferred via resonator 104 to the conductive material of the second portion 108 of the housing 102. The conductive material of the second portion 108 is then able to dissipate the heat to the ambient environment. In the case where the resonators 104 and the tuning screw 128 are also made of a conductive material, the resonators 104 and the tuning screw 128 help to further conduct the heat generated by the electrical current flow towards the conductive material of the second portion 108.

As described in the background of the invention, it is generally understood in the art that the quality of power handling of a comb-line filter is determined by its ability to effectively dissipate heat generated by insertion loss and electrical current flow. More specifically, the better the comb-line filter is at dissipating heat, the better its power handling capabilities will be. The comb-line filter 100 in accordance with embodiments of the present invention is capable of handling a higher power than a conventional plastic comb-line filter, due to the fact that the resonators 104 are attached to the second portion 108 of the housing, which is made of a conductive material, so as to help the filter 100 to dissipate the heat generated by the conductor losses caused by surface resistance and electrical current flow.

Moreover, the fact that the present invention includes a first portion of the housing that is made of a relatively light and inexpensive dielectric material, and a second portion of the housing that is made of a conductive material for mounting the resonators 104 thereto, combines the lightweight, and cost-savings advantages of a plastic housing with the heat dissipation and power handling capabilities of a metal housing.

Second Embodiment 200

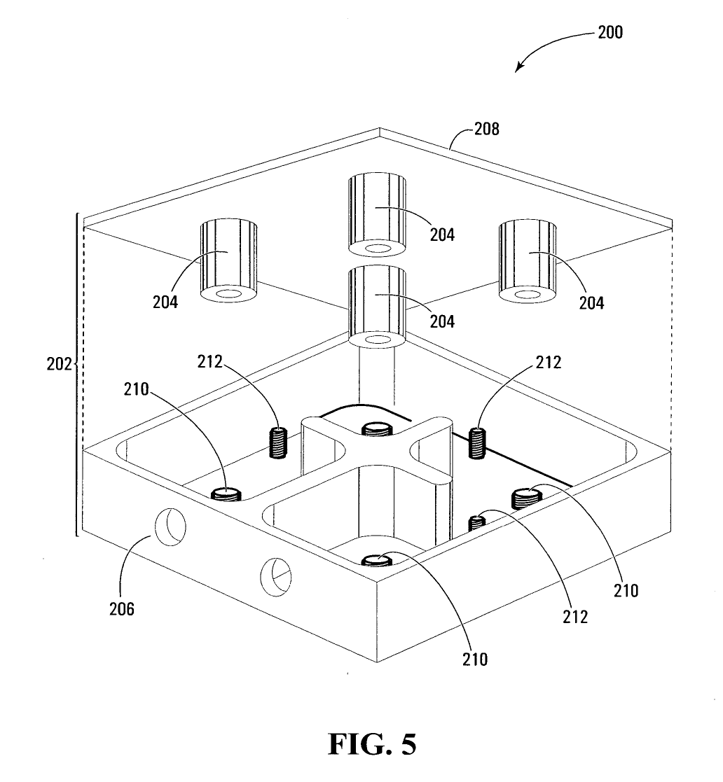

Shown in FIG. 5 is an exploded view of a comb-line filter 200 in accordance with a second non-limiting example of implementation of the present invention. Similarly to the comb-line filter 100 as described above with respect to FIGS. 1 and 2, comb-line filter 200 includes a housing 202 and a plurality of resonators 204. The housing 202 includes a first portion 206 and a second portion 208. The first portion 206 is made of a dielectric material and the second portion 208 is made of a conductive material. As shown, the plurality of resonators 204 are attached to the second portion 208 of the housing 202, which is the portion made of a conductive material.

In this embodiment, the comb-line filter 200 includes a plurality of tuning screws 210 for adjusting the response characteristics of the comb-line filter, and a plurality of coupling screws 212 for further adjusting the response characteristics of the comb-line filter 100. The coupling screws 212 are positioned between respective resonators 204 for directing the wireless signals from one resonator 204 to the next.

In this embodiment, the tuning screws 210 and the coupling screws 212 are connected to the first portion 206 of the housing 202. As such, the tuning screws 210 and the coupling screws 212 extend through holes in the first portion 206 of the housing 102 and extend within the interior chamber. In this embodiment, the tuning screws 210 approach the resonator 204 from the opposite side of the housing 202.

The tuning screws 210 are operative to adjust the desired response characteristics of the comb-line filter 200. More particularly, the tuning screws 210 can be rotated from the bottom surface of the first portion 206, to control the extent to which the tuning screws 210 extend towards the resonators 204. This changes the characteristics of the signal pathway, which changes the frequency response characteristics of the comb-line filter 200. It is noted that even when the tuning screws 210 are in a maximally extended position, the tuning screws 210 could extend within the resonator 204. However, the diameter of the central hole within the resonator 204 will be larger than the diameter of the tuning screw 210 such that there will be a separation between each tuning screw 210 and its respective resonator 104. This should be sufficient to prevent a breakdown of the electric field existing therebetween.

Although FIGS. 1, 2 and 5 show the first portions 106 and 206 as being made of a single part, it should be understood that the first portions 106 & 206 can be made of multiple parts that are all made of a dielectric material. For example, the bottom wall of the first portions 106 and 206 can be formed as a separate component, and can be made of a different dielectric material.

Third Embodiment 300

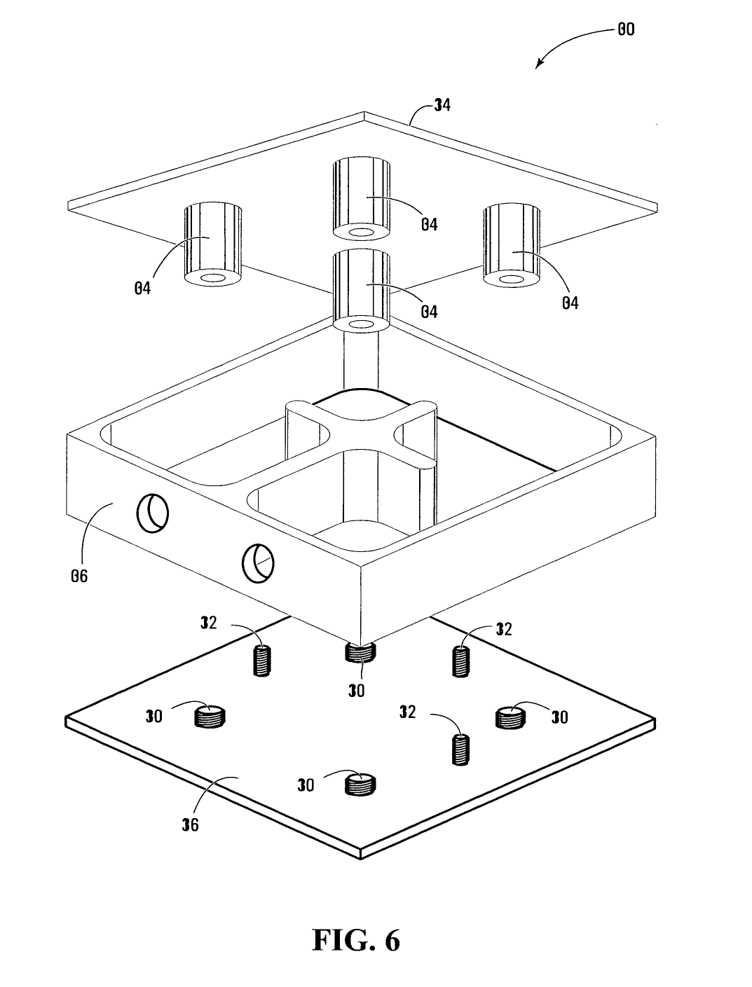

Shown in FIG. 6 is an exploded view of a comb-line filter 300 in accordance with a third non-limiting example of implementation of the present invention. Comb-line filter 300 includes a housing 302 and a plurality of resonators 304.

The housing 302 includes a first portion 306 and a second portion 308. In this non-limiting embodiment, the second portion 308 comprises two parts, namely a first part 314 and a second part 316. In a preferred embodiment, the first portion 306 is made of a dielectric material and both the first part 314 and the second part 316 of the second portion 308 are made of a conductive material.

The first portion 306 and the second portion 308 are adapted to be attached together, so as to define an interior chamber. When attached together, the first portion 306 of the housing 302 is sandwiched between the first part 314 and the second part 316 of the second portion 308 of the housing 302. As such, the first part 314 of the second portion 308 forms the top wall 318 of the housing 302 and the second part 316 of the second portion 308 forms the bottom wall 320 of the housing 302.

In this embodiment, the plurality of resonators 304 are attached to the first part 314 of the second portion 308, and the tuning screws 310 and coupling screws 312 are attached to the second part 316 of the second portion 308. As such, both the resonators 304 and the tuning screws 310 and coupling screws 312 are connected to the conductive material of the second part 308.

In the embodiment shown, the plurality of tuning screws 310 extend through holes in the second part 316 of the second portion 308 such that they extend towards the resonators 304 from the opposite side of the housing 302. The tuning screws 310 can be used to adjust the response characteristics of the comb-line filter 300. More particularly, the tuning screws 310 can be rotated from the bottom surface of the second part 316, in order to control the extent to which the tuning screws 310 extend from the end of the resonators 304. This changes the characteristics of the signal pathway, which changes the frequency response characteristics of the comb-line filter 100. It is noted that even when the tuning screws 310 are in a maximally extended position, the tuning screw 310 could extend within the resonator 304. However, the diameter of the central hole within the resonator 304 will be larger than the diameter of the tuning screw 310, such that there will be a separation between each tuning screw 310 and its respective resonator 304, which should be sufficient to prevent a breakdown of the electric field existing therebetween.

The plurality of coupling screws 312 are further operative for adjusting the response characteristics of the filter 300. The coupling screws 312 are positioned between respective resonators 304 for directing the wireless signals from one resonator 304 to the next. It should be noticed that in this embodiment, the tuning screws 310 and the coupling screws 312 are connected to the second part 316 of the second portion 308. However, in an alternative embodiment, the tuning screws 310 and the coupling screws 312 could be attached to the first part 314 of the second portion 308.

Although the comb-line filers 100, 200 and 300 shown in FIGS. 1, 2, 5 and 6 show four (4) resonators, it should be understood that any number of resonators could have been shown without departing from the spirit of the invention.

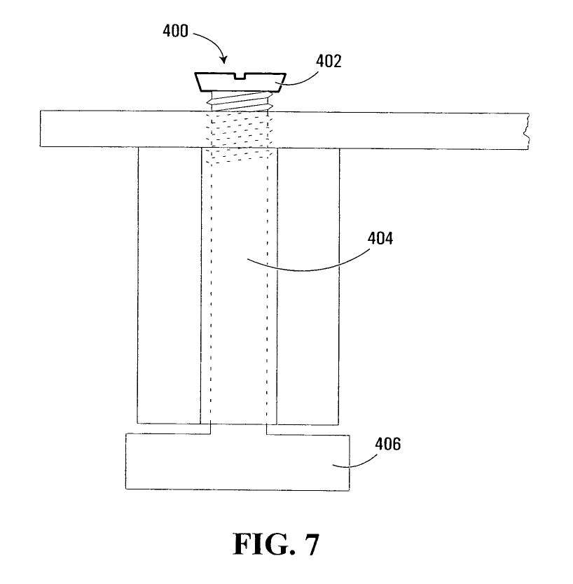

Shown in FIG. 7 is an alternative example of a tuning screw 400. The tuning screw 400 includes a threaded portion 402 that is adapted for being positioned within a threaded hole in the second portion of the housing. The tuning screw 400 further includes a central rod 404 that is adapted for extending through a resonator, and a cylindrical end portion 406 that is connected to the central rod 404. It should be understood that the tuning screw 400 can be used within any of the comb-line filters 100, 200 and 300 described above, without departing from the spirit of the invention.

In addition, and although not described above, in a further non-limiting embodiment of the present invention, the first portion 106 of the housing 102 is made of a material having a lighter density than the second portion 108, so as to form a lightweight filter. In such an embodiment, the dielectric material is of a lighter density than the conductive material.

In yet another alternative embodiment, both the first portion 106 and the second portion 108 can be made of conductive materials, wherein the first portion 106 is made of a conductive material having a lighter density than the conductive material of the second portion 108. For example, if the second portion 108 is made of aluminum, then the first portion 106 can be made of magnesium. In this alternative embodiment, the plurality of resonators 104 are attached to the second portion 108 that is made of a material having a higher density than the first portion 106.

In yet another alternative embodiment, the second portion 108 of the housing 102 is provided with a conductive layer that is more conductive than the material of the first portion 106, or that is more conductive than a conductive layer provided on the first portion 106. For example, the first portion 106 can be made of aluminum and have no conductive layer thereon, and the second portion 108 can be provided with a conductive layer made of silver that is more conductive than the aluminum of the first portion 106. In such an embodiment, the resonators 104 are attached to the second portion 108 that includes the more conductive material. In an alternative embodiment, the first portion 106 can be provided with a first conductive layer, and the second portion 108 can be provided with a second conductive layer, wherein the second conductive layer is more conductive than the first conductive layer. In such an embodiment, the resonators 104 are connected to the second portion 108 that is provided with the second conductive layer. As such, in both of the above embodiments, the resonators 104 are connected to the portion of the filter that includes the more conductive material.

The comb-line filters in accordance with the embodiments described above provide relatively low-cost and light-weight composite material comb-line filters.

The above description of embodiments should not be interpreted in a limiting manner since other variations, modifications and refinements are possible within the spirit and scope of the present invention. The scope of the invention is defined in the appended claims and their equivalents.

1. A comb-line filter comprising:
a) a housing comprising:
i. a first portion made of a dielectric material; and
ii. a second portion made of a conductive material, said first portion and said second portion adapted for being attached together so as to define an interior chamber for conducting signals;
b) at least one resonator attached to said second portion, and adapted for extending within the interior chamber when said first portion and said second portion are attached.

2. A comb-line filter as defined in claim 1, wherein said first portion is made of plastic.

3. A comb-line filter as defined in claim 1, wherein said at least one resonator and said second portion are made of said conductive material.

4. A comb-line filter as defined in claim 1, wherein said at least one resonator is made of at least one metal material.

5. A comb-line filter as defined in claim 1, wherein said at least one resonator is made of a ceramic material.

6. A comb-line filter as defined in claim 1, wherein said at least one resonator is made of a thermoplastic material.

7. A comb-line filter as defined in claim 3, wherein said conductive material includes aluminum.

8. A comb-line filter as defined in claim 1, wherein said first portion includes an inner surface and said second portion includes an interior surface, said inner surface and said interior surface defining said interior chamber, said inner surface and said interior surface being provided with a conductive layer.

9. A comb-line filter as defined in claim 8, wherein said conductive layer includes silver.

10. A comb-line filter as defined in claim 8, wherein said inner surface is provided with a conductive layer having a different conductivity than the conductive layer of said interior surface.

11. A comb-line filter as defined in claim 1, wherein when said first portion and said second portion are attached together, said interior chamber is defined by a top wall, a lower wall and at least one side wall connecting said top wall to said bottom wall.

12. A comb-line filter as defined in claim 11, wherein said first portion includes said at least one side wall.

13. A comb-line filter as defined in claim 12, wherein said interior chamber includes a signal pathway when said first portion and said second portion are attached together, said signal pathway being defined by at least one interior wall.

14. A comb-line filter as defined in claim 11, further comprising a plurality of tuning screws for adjusting a response characteristic of said filter.

15. A comb-line filter as defined in claim 14, wherein said plurality of tuning screws are connected to said first portion of said housing.

16. A comb-line filter as defined in claim 14, wherein said plurality of tuning screws are connected to said second portion of said housing.

17. A comb-line filter as defined in claim 16, wherein at least one of said plurality of tuning screws extends through a center of a respective one of said at least one resonator.

18. A comb-line filter as defined in claim 14, wherein said second portion comprises a first part that forms said top wall, and a second part that forms said bottom wall, said at least one resonator being attached to said first part and said plurality of tuning screws being connected to said second part.

19. A comb-line filter as defined in claim 1, wherein said dielectric material and said conductive material have thermally compatible respective coefficients of thermal expansion.

20. A comb-line filter as defined in claim 12, wherein said dielectric material and said conductive material have respective coefficients of thermal expansion within 10% of one another.

21. A comb-line filter as defined in claim 11, further comprising a plurality of coupling screws for adjusting a response characteristic of said filter.

22. A comb-line filter as defined in claim 21, wherein said plurality of coupling screws are connected to said first portion of said housing.

23. A comb-line filter as defined in claim 1, wherein said dielectric material is of a first density and said conductive material is of a second density, said first density being less than said second density.

24. A method of manufacturing a comb-line filter, comprising:
a) providing a first portion made of a dielectric material;
b) providing a second portion made of a conductive material, said second portion having at least one resonator connected thereto;
c) attaching said first portion and said second portion together in order to form an interior chamber suitable for conducting signals.

25. A method as defined in claim 24, wherein said internal chamber is defined by an inner surface of said first portion and an interior surface of said second portion, said method further comprising providing a conductive layer on said inner surface and said interior surface.

26. A method as defined in claim 25, wherein said at least one resonator is configured and positioned on said second portion so as to achieve a desired frequency response.

27. A method as defined in claim 24, wherein said at least one resonators are made separately form said second portion.

28. A comb-line filter comprising:
a) a housing comprising:
i. a first portion made of a material of a first density; and
ii. a second portion made of a metal material of a second density, said first density being less than said second density, said first portion and said second portion adapted for being attached together so as to define an interior chamber for conducting signals;
b) at least one resonator attached to said second portion, and adapted for extending within the interior chamber when said first portion and said second portion are attached.

29. A comb-line filter comprising:
a) a housing comprising:
i. a first portion made of a first material; and
ii. a second portion made of a second material, said second portion being provided with a conductive layer, said conductive layer being more conductive than said first material of said first portion, said first portion and said second portion adapted for being attached together so as to define an interior chamber for conducting signals;
b) at least one resonator attached to said second portion, and adapted for extending within the interior chamber when said first portion and said second portion are attached.

30. A comb-line filter as defined in claim 29, wherein said first portion is provided with a respective conductive layer, said conductive layer of said second portion being more conductive than said conductive layer of said first portion.
